(19) United States
(12) Patent Application Publication
(10) Pub. No.: US 2026/0246815 A1
(43) Pub. Date: Aug. 20, 2026

(54) WEB BROWSER NATIVE IDENTITY SECURITY

(71) Applicant: Palo Alto Networks, Inc., Santa Clara, CA (US)

(72) Inventors: Yan Aksenfeld, Rehovot (IL); Shlomi Zrahia, Tel Aviv (IL); Ofer Ben-Noon, Tel Aviv (IL); Ohad Bobrov, Tel Aviv (IL)

(21) Appl. No.: 19/279,698

(22) Filed: Jul. 24, 2025

Related U.S. Application Data
(60) Provisional application No. 63/760,721, filed on Feb. 20, 2025.

(51) Int. Cl. H04L 9/40

(52) U.S. Cl. CPC H04L 63/20; H04L 63/08

(57) ABSTRACT

A web browser has been created that can operate as a unified platform for managing, monitoring, and controlling identity data to reduce or eliminate the security gaps in identity security. As the primary conduit for fragmented identity security services, the web browser has access to identity data across the identity security fragments and silos.

The unifying web browser includes monitoring functionality at the browser engine and/or the rendering engine and captures events that relate to identity security.

### BACKGROUND

The disclosure generally relates to web browser native identity security (e.g., CPC subclass G06F 21/00).

Identity security has been addressed by Identity and Access Management (IAM) systems, Identity Governance and Administrator (IGA) systems, and Privileged Access Management (PAM) systems. IAM is a framework of policies and technologies for managing identities and access of resources by those identities. IAM technologies typically involve a configuration phase and an operational phase. In the configuration phase of IAM, an identity is registered and credentials provisioned; then access is authorized to the registered identity. In the operational phase of IAM, an identity is authenticated by a credential(s) and then access is controlled accordingly. A common IAM technology is single sign-on (SSO). PAM involves the control, monitoring, and protection of privileged accounts, which are accounts with enhanced permissions and are often targets of malicious actors. IGA relates to visibility of identity data, auditing, and risk identification.

### BRIEF DESCRIPTION OF THE DRAWINGS

Embodiments of the disclosure may be better understood by referencing the accompanying drawings.

FIG. 1 is a diagram of a web browser with a browser architecture that allows the web browser to provide a unified platform for identity security across the pillars of governance, management, and control.

FIG. 2 is a flowchart of example operations for capturing identity security data for an organization wide inventory.

FIG. 3 is a diagram of a web browser with browser native password management.

FIG. 4 is a flowchart of example operations for natively managing passwords with a web browser.

FIG. 5 is a diagram of a web browser with browser native last mile control over application login.

FIG. 6 is a flowchart of example operations for web browser native control of login according to a security policy.

FIG. 7 is a flowchart of example operations for evaluating a password of a login event against password hygiene rules and determining whether the password is compliant.

FIG. 8 depicts an example computer system with a web browser that includes native identity security.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Introduction

The silos of identity security (i.e., PAM, IAM, and IGA) have resulted in gaps in security because the technologies deployed fragment identity security. Moreover, numerous vendors providing different technologies exacerbate fragmentation of identity security. For instance, an organization will have one or more identity providers (IdP) that provide SSO for managed applications and a different provider that provides PAM for critical systems of the organization. The organization will use legacy applications that use legacy login technology. In addition, users of the organization will share passwords and create shadow information technology (IT) by accessing unsanctioned applications for work and/or by accessing personal accounts of personal services.

### Overview

A web browser has been created that can operate as a unified platform for managing, monitoring, and controlling identity data to reduce or eliminate the security gaps in identity security. As the primary conduit for fragmented identity security services, the web browser has access to identity data across the identity security fragments and silos. The unifying web browser includes monitoring functionality at the browser engine and/or the rendering engine and captures events that relate to identity security. Monitoring events at this level allows the web browser to capture events prior to potential tampering beyond the browser (e.g., a browser extension) and/or rendering engine. Monitoring at this level also provides the web browser access to a greater amount of identity related events because the web browser will have visibility of data before being encrypted by a networking layer or after decryption by the networking layer of the web browser. The web browser, along with other instances of the web browser deployed across an organization, delivers the identity related events or identity data extracted from the identity related events to an identity security service of the organization. The organization builds an inventory of the identity events/data which facilitates an organization-wide view of the identity attack surface. Analysis of this comprehensive identity data reveals risks at a granularity that allows the web browser to effectively and efficiently reduce or eliminate those risks, as well as manage security posture via the web browser instances.

One of the aforementioned security gaps that primarily arises from user behavior involves password hygiene. Password hygiene poses a significant security challenge for any organization. Typically, it is addressed through user education and falls outside the direct control of the security team. For instance, users often reuse their identity provider (SSO) passwords on other corporate websites or, even worse, on unsanctioned or personal sites. Additionally, weak passwords may be used on platforms that hold sensitive company data.

The web browser can impose a security mechanism for more robust password management in accordance with organization policy at the browser/rendering engine level that at least addresses password hygiene with web browser native password management. Analysis of the identity inventory may reveal an application to protect with stronger password management by the web browser. After the application is identified to the web browser, the web browser monitors events for a login event for the application. The web browser generates a new password that satisfies organization requirements and prompts the user attempting to login to the application to reset the password with the web browser generated password. However, the web browser does not present the web browser generated password with a typical masking mechanism that has weaknesses allowing exposure of the password. Instead, the web browser presents, via the rendering engine, a string that appears to be a masked password. The web browser generated password does not surface to the user interface or to any user interface subsystem of the web browser. The web browser uses the new password to authenticate the user with the application and stores an association of the password and the application in a secure location with the data persistence subsystem of the web browser.

Furthermore, the web browser can detect login weaknesses and impose security measures on logins in general according to organization policy with the browser/rendering engine level monitoring of events. The web browser can monitor events to the browser/rending engine for login events. When a login event is detected, the web browser evaluates the login against an identity security policy that can specify login methods, credential requirements, etc. Thus, organizational deployments of this web browser with the identity security functionality/architecture provides an organization last mile control over login methods across the organization.

### Example Illustrations

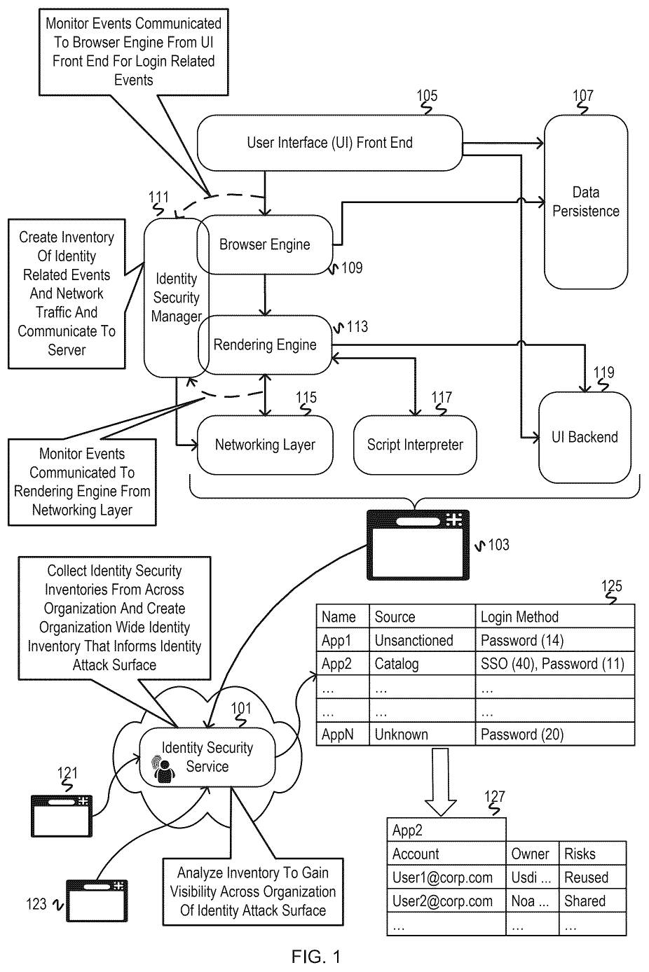

FIG. 1 is a diagram of a web browser with a browser architecture that allows the web browser to provide a unified platform for identity security across the pillars of governance, management, and control. FIG. 1 depicts deployment of web browser instances 103, 121, 123 across an organization. As examples, the web browser instances 103, 121, 123 are enterprise browsers deployed across managed devices of the organization whether remote or onsite and unmanaged devices that employees, contractors, etc. use to access assets of the organization. FIG. 1 also depicts an identity security service 101 that has access to the web browser instances 103, 121, 123 and/or receives communications from the web browser instances 103, 121, 123.

FIG. 1 depicts an architecture of the web browser instance 103. The architecture includes several subsystems: a user interface (UI) front end 105, data persistence 107, browser engine 109, rendering engine 113, networking layer 115, script interpreter 117, and UI backend 119. Web browser architecture can vary by browser implementation, but generally have the depicted subsystems. For instance, web browser implementations can be designed according to an architecture that has a rendering engine that encompasses the functionality of a browser engine. The architecture depicted in FIG. 1 also includes an identity security manager 111. The identity security manager 111 is depicted as overlapping with the browser engine 109 and the rendering engine 113. This overlapping represents different possible implementations for the identity security manager 111. The identity security manager 111 can be a distinct subsystem that communicates with the browser engine 109 and the rendering engine 113. The identity security manager 111 can be implemented as a wrapper around the browser engine 109 and rendering engine 113. The identity security manager 111 can be implemented as extension or add-on functionality. Furthermore, the browser engine 109 and/or rendering engine 113 may be modified to incorporate functionality of the identity security manager 111.

Regardless the implementation, the identity security manager 111 monitors events communicated to the browser engine 109 from the UI front end 105. The identity security manager 111 monitors the communicated events for login related events. For example, the browser engine 109 may have an event listener or a defined interface object for events from the UI front end 105. The identity security manager 111 can intercept events or register its own event listener with the UI front end 105. When an event is detected, the identity security manager 111 examines the event to determine whether it is a login related event.

The identity security manager 111 also monitors events communicated from the networking layer 115 to the rendering engine 113 or the browser engine 109 depending on web browser implementation. Events from the networking layer 115 include receipt of responses to requests submitted to the networking layer 115. The responses can indicate an authentication token, an authentication service, an authentication state, etc. The identity security manager 111 examines the responses to determine which relate to login events.

As the identity security manager 111 detects login related events either from the UI front end 105 or the networking layer 115, the identity security manager 111 builds a local inventory of identity related events. Building the local inventory can involve recording events into a dataset or extracting select data from the events, such as application identifier, event type, etc. The identity security manager 111 can maintain the local inventory of identity security data in secure storage via the data persistence subsystem 107.

At some point, the identity security service 101 collects the local identity security inventories from the web browser instances 103, 121, 123. Trigger for collection may be time-based (e.g., recurring expiration of a time interval) or event-based (e.g., initial collection and manual command). The identity security service 101 may query and retrieve the local inventories from the browser instances 103, 121, 123. The web browser instances 103, 121, 123 may communicate their local inventories to the identity security service 101 based on a trigger. With the collected identity security data inventories, the identity security service creates an organization wide identity security data inventory (“global identity inventory”). To maintain the global identity inventory, collection of local inventories recur to capture the many changing aspects of identity security and changes in the organization.

The global identity inventory informs the identity attack surface of the organization. The identity security service 101 analyzes the global identity inventory to discover risks and vulnerabilities. In FIG. 1, analysis of the global identity inventory yields a view 125 that presents the applications identified in login related events across the organization and security relevant characteristics. The identity security service 101 can interface with other data sources to determine sources of the discovered applications. The analytical view 125 indicates that an Appl is an unsanctioned application, that an App2 is from an organization approved application catalog, and that an AppN has an unknown source. Examining information from an IdP for an organization can inform determination of a risk category for an application (e.g., sanctioned, catalog, unsanctioned, unknown). For instance, the identity security service 101 can compare an application identifier in the identity inventory against a listing of applications indicated by an IdP for an organization to determine the risk category. The view 125 indicates that password-based login was used for 14 accounts with App1, for 11 accounts with App2, and for 20 accounts with AppN. The view 125 also indicates that SSO was used to authenticate 40 accounts with App2. Additional information that can be discerned from analyzing the global identity security inventory, such as risk flags and vulnerabilities, but the additional information is not depicted due to space constraints.

A view 127 presents more granular information from the global identity inventory for App2. Assuming the views are presented in a graphical user interface (GUI), the App2 entry in the view 125 can be selected and view 127 presented in response to the selection. The view 127 lists the accounts associated with App2 indicated in the global identity inventory and an owner/user of each of the accounts, as well as risks detected for each account. The view 127 indicates that the account for User1@corp. com has a detected risk of a password being reused with either another account of App2 or for an account of the same owner in a different application indicated in the global identity inventory. The view 127 also indicates that risk of password sharing was detected for the account User2@corp.com.

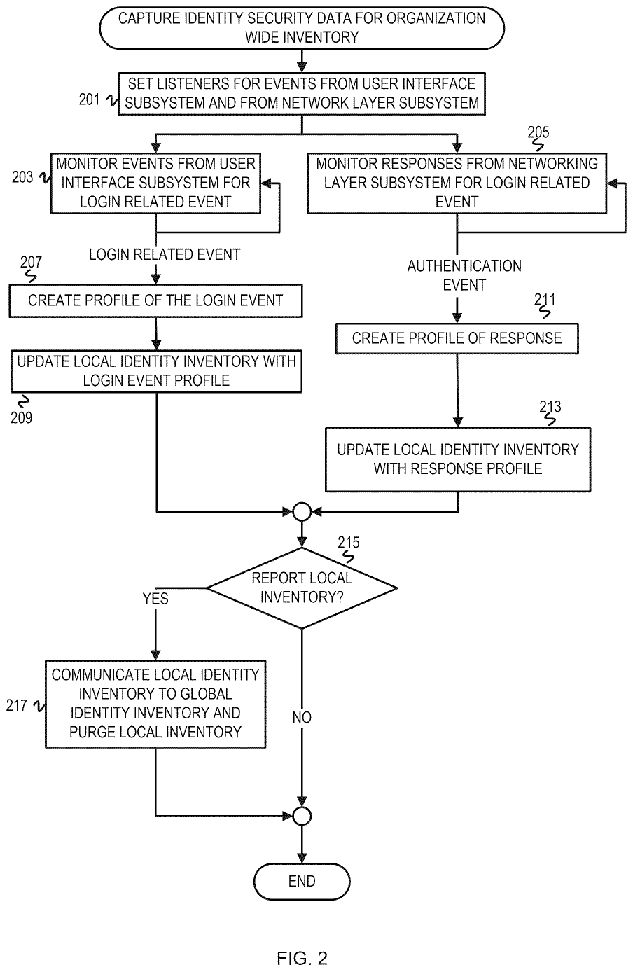

FIG. 2 is a flowchart of example operations for capturing identity security data for an organization wide inventory. The example operations are described with reference to a web browser. Implementations may involve a sequence that requires a user to login to the web browser itself. While the credential(s) used to login to the web browser may also be collected, the example operations in FIG. 2 relate to login events corresponding to a web-based application/service (e.g., Software-as-a-Service (Saas), Infrastructure-as-a-Service (IaaS), etc.).

At block 201, the web browser sets listeners for events from a UI subsystem and from a network layer subsystem. The browser and rendering engines are programmed with event listening and handling functionality. While the functionality for listening for events and handling events is sometimes described with references to event handlers and event listeners, the functionality is often implemented as a single component (i.e., method or function). The web browser can instantiate event listeners and handlers for identity data monitoring, or the functionality of the browser and rendering engines can be programmed differently incorporate the identity data monitoring and collection tasks. If the web browser instantiates listeners and handlers distinct from the listeners and handlers of the engines, then the listeners and handlers for identity security may be implemented as wrappers around the engines to facilitate interception of events. Alternatively, the event listening and handling program code of the engines can be implemented to distinguish identity related events from other events and capture the corresponding data. In addition, a web browser may spawn separate processes per web browser tab. In these cases, the event listening/handling functionality would be duplicated per spawned process.

At block 203, the web browser monitors events from the UI subsystem for a login related event. Monitoring events from the UI subsystem will be at the browser engine or a browser engine interface unless the web browser is implemented according to an architecture that subsumes browser engine functionality into the rendering engine, in which case the monitoring is at a rendering engine interface. The web browser evaluates each detected event from the UI subsystem against indicators of a login related event. For instance, the web browser can determine whether the event indicates a form submission that includes a field matching a regular expression corresponding to a credential field. The web browser can evaluate the query component of a uniform resource locator (URL) against a pattern or regular expression that has been determined as corresponding to a login related event. As another example, the web browser can examine page elements, structure and/or layout based on underlying program code or objects (e.g., document object model, hypertext markup language code, etc.) or image based examination. As an example of image based examination for login detection, the web browser can capture the rendered screen and prompt a multi-model language model to identify whether the captured screen corresponds to a login. The monitoring is ongoing and continues even when a login related event is detected. When a login related event is detected, operational flow proceeds to block 207.

At block 205, the web browser monitors responses to web page requests from the networking layer subsystem. Monitoring events from the network layer subsystem may be at the rendering engine and/or the browser engine depending on implementation of how the web browser handles messages received from the network layer subsystem. The web browser can examine outgoing requests and incoming responses for login protocols (OpenID Connect (OIDC), Security Assertion Markup Language (SAML), Web Authentication (WebAuthN) and/or patterns in responses or requests previously ascertained as corresponding to login. Receipt of a response from the network layer subsystem is an event and the description will refer to a received response as a detected event. However, the login related event in this case is more specifically an authentication related event. Similar to monitoring events from the UI subsystem, the web browser evaluates responses against indicators of a response that corresponds to an authentication response. The web browser can evaluate the URL for a domain that corresponds to a service provider corresponding to identity, such as an IdP, password manager, or PAM service. The web browser can also examine other components of the URL and a header of the response message for an indicator that the response message corresponds to authentication. Monitoring for a login/authentication related response is ongoing even if operational flow proceeds to block 211 when a login related response is received.

The web browser can leverage the intelligence of a foundation model (e.g., a large language model (LLM)) for detection of events that relate to login. The web browser can include a component that interacts with an embedded artificial intelligence (AI) agent to query a LLM in-line to determine whether an event relates to login. Alternatively, the LLM can be prompted to provide patterns or criteria of events from a web browser UI and network message events that relate to login. The prompt to the LLM can include samples of document object models (DOMs) and hypertext transfer protocol (HTTP) messages for identifying login related events. The responses from the LLM can then be used to configure and periodically update a web browser to distinguish login related events from other events.

At block 207, the web browser creates a profile of the login event detected from monitoring the UI generated events. To create a profile, the web browser extracts identity security relevant data from the event or copies the event. The profile at least includes an application identifier and a user credential or account identifier. These can be extracted from form fields and/or a URL.

At block 209, the web browser updates a local identity inventory with the login event profile. The web browser maintains an inventory of the login related profiles locally. The web browser can interact with the data persistence subsystem to store the local inventory into a secure memory space isolated from all other processes or in an encrypted memory/storage that can only be decrypted by the creating process. The web browser adds an entry or record into the local inventory with the created profile. Operational flow proceeds to block 215.

At block 211, the web browser creates a profile of the authentication related event detected from monitoring responses from the networking layer subsystem. To create a profile, the web browser extracts identity security relevant data from the response or copies the response. The profile at least includes an application identifier, user or account identifier, domain name indicated in a URL of the response, and the type of authentication response. These can be extracted from the header and body of the response.

At block 213, the web browser updates the local identity inventory with the response profile. The local identity inventory will have an entry for a login related event corresponding to the response. The web browser searches the local inventory for a correlating value, such as a session identifier, and then updates the corresponding entry with the response profile. Operational flow proceeds to block 215.

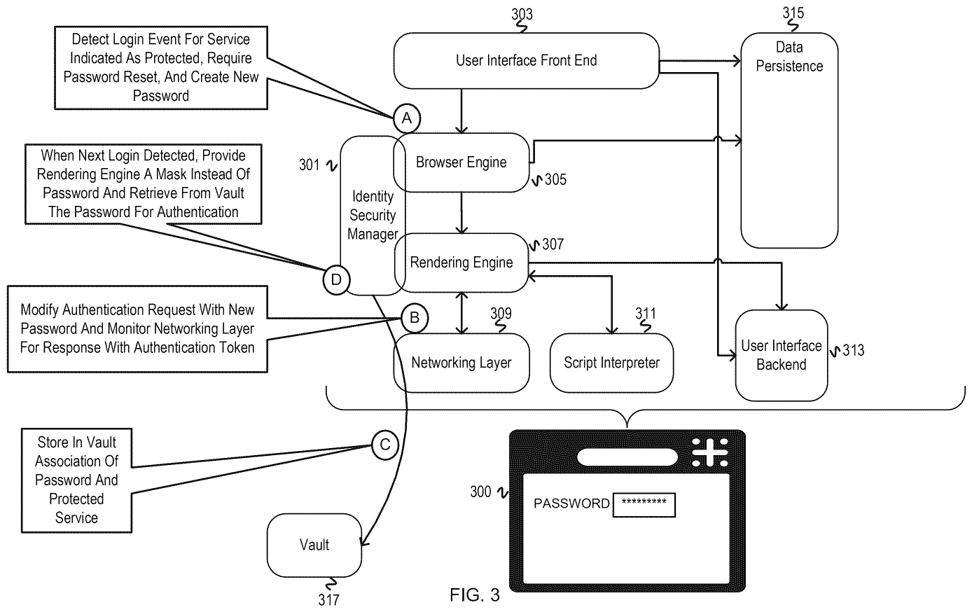

At block 215, the web browser determines whether to report the local inventory of identity data. As previously mentioned, reporting for organization-wide collection of local identity data inventories can be based on a time-based trigger or event-based trigger. If the web browser determines that the local inventory of identity data should be reported to the organization's identity security service, then operational flow proceeds to block 217. Otherwise, operational flow ends for FIG. 3, although operations 203 and 205 are ongoing.

At block 217, the web browser communicates the local identity inventory to global identity inventory and purges the local inventory. To comply with a security posture management policy or rule for the endpoint device that hosts the web browser, the local inventory is purged after acknowledgement of receipt. Other implementations may purge the local inventory less frequently or use hardware backed encryption to encrypt the local inventory.

FIG. 3 is a diagram of a web browser with browser native password management. FIG. 3 depicts an architecture of a web browser 300 similar to the web browser architecture depicted in FIG. 1. The architecture includes several subsystems: a UI front end 303, data persistence 315, browser engine 305, rendering engine 307, networking layer 309, script interpreter 311, and UI backend 313. The architecture depicted in FIG. 3 also includes an identity security manager 301. The identity security manager 301 is depicted as overlapping with the browser engine 305 and the rendering engine 307 for a similar reason as explained in FIG. 1.

FIG. 3 is annotated with a series of letters A-D representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the identity security manager 301 detects a login event for a service indicated as protected. A service/application can be indicated as requiring strong password protection via security policy enforced by the web browser 300. As another example, an organization's identity security service can communicate to the web browser 300 based on analysis of global identity inventory that the service requires a stronger password protection. In some cases, the identity security manager 301 may enforce stronger password protection on any application or service associated with the organization. In this case, the identity security manager 301 would evaluate the event to determine whether it is a login event for one of a predefined list of services and determine whether the service is already protected. Based on the detection of the login event for the service to be protected, the identity security manager 301 requires a password reset for the service. The identity security manager 301 can indicate to the rendering engine 307 a prompt to the user to reset the password for the service or submit a request to the service for a password reset for a user or account identifier. The identity security manager 301 then creates a new password that satisfies password requirements of the organization, but does not surface the password to the UI backend 313 or the rendering engine 307. Thus, a user cannot gain visibility of the password by inspecting underlying source of a visible webpage.

At stage B, the identity security manager 301 modifies an authentication request with the web browser generated password. For instance, the password reset corresponds to a form submission to be communicated in a request message for authentication. The identity security manager 301 can capture the request message and insert the browser generated password into the message before passing the request message to the networking layer 309. Subsequently, the identity security manager 301 monitors events from the networking layer 309 for a response with an authentication token.

At stage C, the identity security manager 301 stores an association of the browser generated password and the protected service (e.g., service or application name) in a vault 317. The vault 317 is a remote, secured store/repository of the organization accessible by browser instances that present an authentication token of a user account or the browser itself. For instance, a browser instance may be provisioned an authentication token after being authenticated to the organization. In some embodiments, the vault 317 could be implemented as a protected or isolated memory or storage space owned by the web browser 300 (or web browser process). Data written into the vault 317 is encrypted and can be decrypted with a key or secret owned by/assigned to the web browser 300. Within this vault 317, the identity security manager 301 maintains a dataset of associations of passwords and protected services.

At stage D, the identity security manager 301, when a next login event is detected for the protected service, provides the rendering engine 307 a “mask” instead of the password for the service. The identity security manager 301 will access the vault 317 to determine whether the service of the detected login event is protected. At this point, the service is protected and the identity security manager 301 retrieves the password generated for the service from the vault 317. However, the identity security manager 301 does not provide the password to the rendering engine 307 for masking. Instead, the rendering engine 307 renders in a password field a string that appears to be a mask. When the user selects a control for submission of the password, the identity security manager 301 will detect the login event and insert the retrieved password into a request message created based on the submit action.

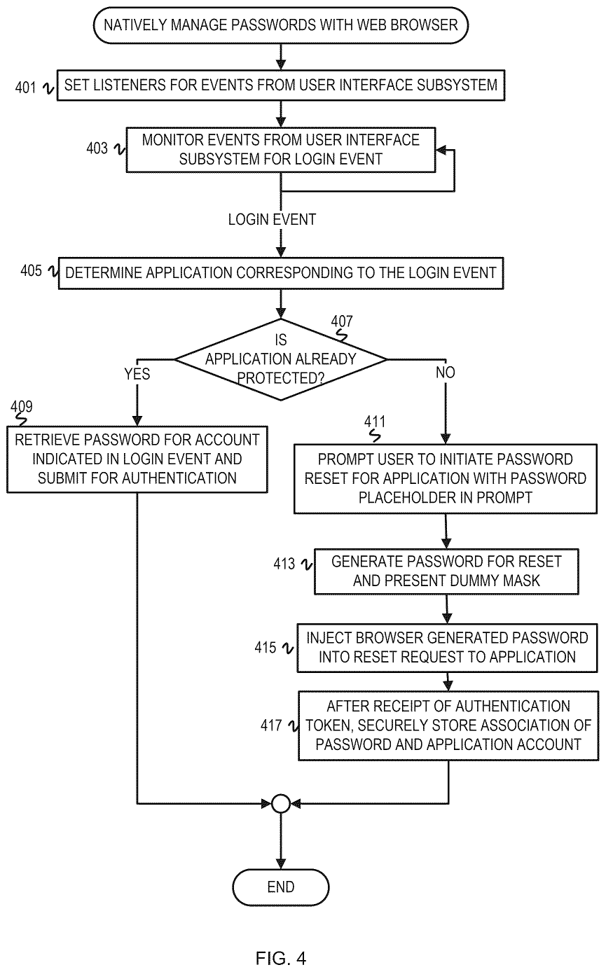

FIG. 4 is a flowchart of example operations for natively managing passwords with a web browser. Natively managing passwords with a web browser instead of a plug-in or extension allows an organization full visibility of passwords submitted to a password and in-situ control with greater security at least by preventing surfacing of passwords to a rendering engine. Managing passwords natively with a web browser uses some of the same techniques described earlier to detect relevant events. Operations substantially similar to those already described will only be repeated briefly.

At block 401, the web browser sets listeners for events from a UI subsystem.

At block 403, the web browser monitors events from the UI subsystem for a login event. Unlike the data inventory monitoring, browser native password management is monitoring for login events that involve submission of a password, whether already associated with an account of a service or being created for a service.

At block 405, the web browser determines an application corresponding to the login event. The web browser can identify the service from the domain name indicated in a URL associated with the login event.

At block 407, the web browser determines whether the application corresponding to the login event is already protected. The web browser determines a user or account credential (e.g., username or account identifier) associated with the browser. For security, a user will either have already authenticated to the web browser or be required to authenticate to the web browser. For instance, a user will have logged into an IdP of the organization. The web browser or the identity security service of the organization can correlate activities with the IdP authenticated user. The web browser accesses a secure memory location with access limited to the web browser (e.g., vault) to determine whether the identified application for the user or account credential is already protected with a browser generated password. If the account for the application is already protected, then operational flow proceeds to block 409. Otherwise, operational flow proceeds to block 411.

At block 409, the web browser retrieves from the vault the browser generated password for the user indicated for the login event and submits a request for authentication. The login event will cause generation of a request message for authentication. The web browser will insert the retrieved password into the request message prior to encryption and transmission by the networking layer.

If the user for the application has not yet been protected with a strong, browser native password, then the web browser prompts the user to initiate a password reset for the application for the associated account/user at block 411. The web browser can indicate to the rendering engine a prompt directing the user to reset the password for the service/application account.

At block 413, the web browser detects the login event that is for resetting the password for the application and generates a password for the password reset. The web browser interacts with the rendering engine to indicate a “dummy mask” for the rendering engine to populate the password field. As stated previously, the dummy mask is not masking the password because the password is not provided to the rendering engine and does not surface to any user interface.

At block 415, the web browser injects the browser generated password into the reset request. When the user performs an action to submit the password reset page/form, the web browser injects the browser generated password into the password field of the request message body before encryption and transmission of the reset request message by the networking layer.

At block 417, the web browser stores into the vault an association of the application account (e.g., application name and user identifier) with the browser generated password. The web browser stores the association after detecting receipt of an authentication token in a response message. With this browser native password management, password sharing does not suffer from the same vulnerability as conventional password sharing. A first user can request sharing of a password in the vault with another user of the organization for an application via the web browser instance of the first user. The sharing request can be communicated from the first user's web browser instance to the identity security service of the organization. The identity security service determines whether the recipient of the sharing is authenticated to another browser instance. Assuming the identity security service identifies the browser instance at which the recipient is authenticated, the identity security service grants that browser instance access to the shared password in the vault, perhaps with a short-lived token or access key. The organization's security policy can define limitations on shared passwords. With this sharing through the web browser, the password remains unexposed beyond the rendering engine of the web browser. Furthermore, the identity security service can grant the second browser instance a use-only permission to the shared password to prevent any resetting or further sharing by the recipient user.

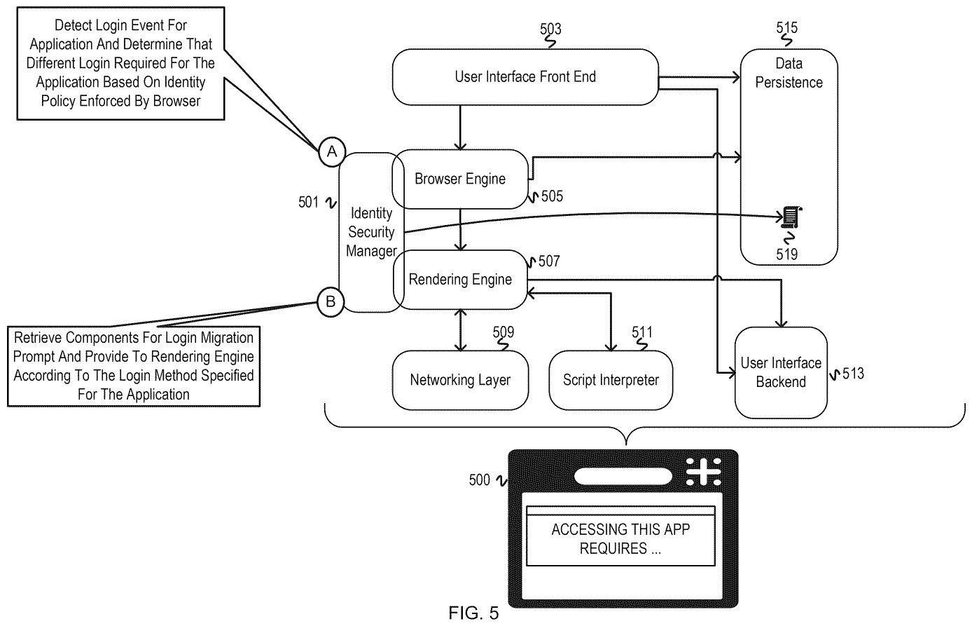

FIG. 5 is a diagram of a web browser with browser native last mile control over application login. FIG. 5 depicts an architecture of a web browser 500 similar to the web browser architectures depicted in FIG. 1 and FIG. 3. The architecture includes several subsystems: a UI front end 503, data persistence 515, browser engine 505, rendering engine 507, networking layer 509, script interpreter 511, and UI backend 513. The architecture depicted in FIG. 5 also includes an identity security manager 501. The identity security manager 501 is depicted as overlapping with the browser engine 505 and the rendering engine 507 for a similar reason as explained in FIG. 1.

FIG. 5 is annotated with a series of letters A-B representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the identity security manager 501 detects a login event for an application and determines that a different login method is required. An organization will have loaded into the web browser 500 a security policy 519 or configured the web browser 500 with the security policy 519. FIG. 5 depicts the web browser 500 as maintaining the security policy in memory or storage accessible via the data persistence subsystem 515. An identity security service of the organization can update the security policy 519 with indications of acceptable or approved login methods for applications. The security policy 519 can specify login methods and credential requirements by application or application class/category. For instance, enterprise applications of the organization may have a login method that requires a biometric and/or hardware-based token login instead of a password. To determine whether the attempted login method is acceptable, the identity security manager 501 determines an application identifier and login method type from the login event and evaluates the determined information against the security policy 519.

At stage B, the identity security manager 501 retrieves page components for a login migration prompt and provides the components to the rendering engine 507. Implementations can configure the identity security manager 501 or the UI front end 503 with the login migration prompt components. Different login migration prompts can be configured for different login method types.

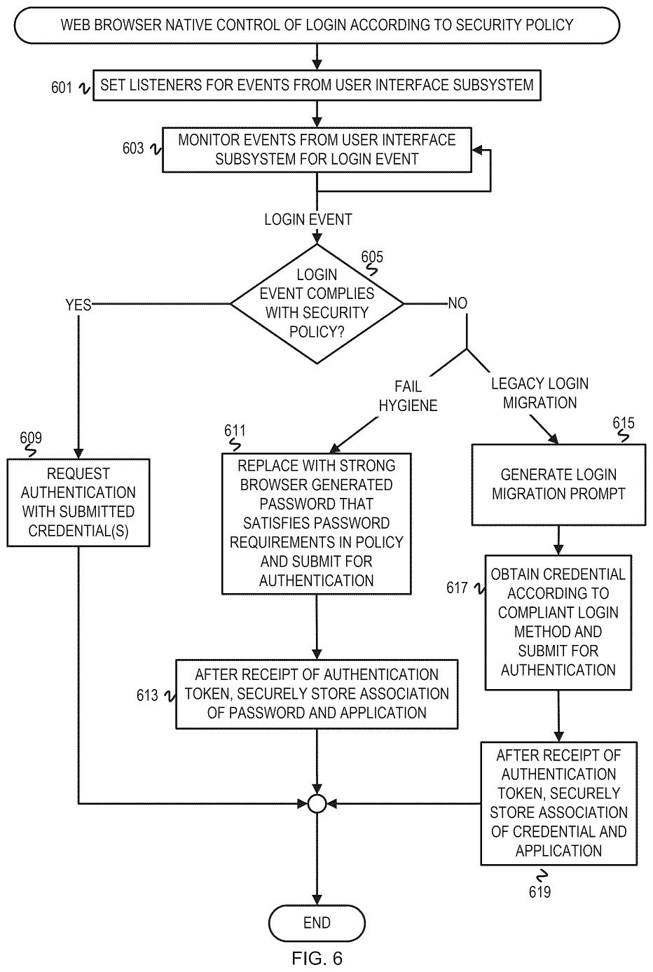

FIG. 6 is a flowchart of example operations for web browser native control of login according to a security policy. With in situ last mile control of login via a web browser, the web browser can be a tool for filling the many security gaps created from identity security fragmentation. The web browser can assess login events against the security policy of an organization and remediate many of the user created vulnerabilities by removing a user from the weaknesses in the authentication sequence. Operations substantially similar to those already described will only be repeated briefly.

The already described operations for detecting relevant events are similar to those already mentioned. At block 601, the web browser sets listeners for events from a UI subsystem. At block 603, the web browser monitors events from the UI subsystem for a login event.

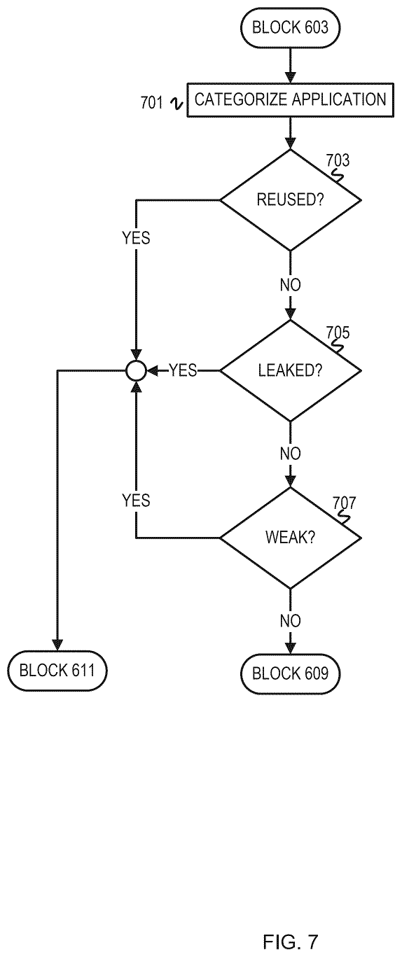

At block 605, the web browser evaluates a detected login event against the security policy and determines whether the login event complies with a security policy enforced by the web browser. The web browser determines an application identifier from the login event and evaluates the security policy based on the application identifier. The web browser may determine that the security policy requires a hard security token to access the application or that a password must satisfy specified password requirements. The web browser may determine that the application does not have a security rule specified in the security policy, for example a security policy may not have a rule for a personal service application. FIG. 7 provides example operations for evaluating a login event against password-based rules in a security policy.

FIG. 7 is a flowchart of example operations for evaluating a password of a login event against password hygiene rules and determining whether the password is compliant. Thus, the example operations of FIG. 7 correspond to block 605. The evaluation of passwords within a web browser allows for preventative, in-line evaluation of passwords before exiting the web browser instead of detecting a failure of password hygiene after password submission. At block 701, the web browser categorizes the application identified for the login event. The web browser can search an application catalog or listing of applications defined as enterprise applications sanctioned for the organization. This can be indicated within the security policy or separately. A password hygiene rule may be specified for an application category instead of a specific application. At block 703, the web browser determines whether the password detected in the login has been reused. The web browser can maintain a listing of passwords (or password hashes) submitted via the web browser for matching and determination of reuse. As passwords are detected, the web browser organizes the passwords by password type. For example, the web browser can organize into groups of categories comprising IdP passwords, non-SSO organization passwords, personal non/low-sensitive passwords (e.g., passwords to social media applications), and personal sensitive passwords (e.g., banking or healthcare related passwords). The security policy may allow reuse within the personal low/non-sensitive password category and no other category. If the password has been reused, then operational flow proceeds to block 611. Otherwise, operational flow proceeds to block 705. At block 705, the web browser determines whether the password has been leaked. The web browser can query a service specified in the security policy or configured in the web browser for leaked passwords. After receipt of the listing of leaked passwords, the web browser can search the listing of leaked passwords to determine whether the password of the detected login event has been leaked. If the password has been leaked, then operational flow proceeds to block 611. Otherwise, operational flow proceeds to block 707. At block 707, the web browser determines whether the password is weak. The web browser evaluates the password against minimum password requirements specified in the security policy or referenced by the security policy. If the password is weak, then operational flow proceeds to block 611. Otherwise, operational flow proceeds to block 609. In addition to the depicted example operations, an alert or notification can be generated if a login event does not comply with a rule in the security policy.

Returning to FIG. 6, if the login event complies with a security policy, then operational flow proceeds to block 609. Otherwise, operational flow proceeds to block 611 or block 615 depending upon the rule against which the login event is non-compliant. Blocks 611 and 615 respectively correspond to failing a password hygiene-based rule in a security policy and a legacy migration related rule in a security policy. These only represent two examples of numerous possible examples of rules that a web browser may enforce against logins detected in the web browser.

At block 609, the web browser requests authentication with the submitted credential(s). The login event would lead to creation of a request message passed to the networking layer of the web browser.

Blocks 611 and 613 correspond to an example execution path when a login event fails a password hygiene-based rule. At block 611, the web browser replaces the password that failed the rule with a strong password generated natively by the web browser. Of course, the web browser would generate the password according to constraints that satisfy the requirements indicated in the security policy. If the login event corresponds to a new password creation, then the web browser would inject the new password into the password creation request being passed to the networking layer. If the login event is not a password creation event, then the web browser would trigger a password reset as described in FIG. 4. Whether a password reset or password creation request, the web browser submits the request via the network layer. At block 613, the web browser securely stores an association of the password and the application account identifier after receipt of the authentication token responsive to the password creation or reset request.

Blocks 615, 617, and 619 correspond to an example execution path when a login is a legacy login that is no longer allowed and must be migrated to a modern login method according to the security policy. At block 615, the web browser generates a login migration prompt. The web browser can retrieve the components of a predefined prompt for legacy login method migration depending upon the type of login being attempted and pass the components to the rendering engine. In addition to the previous implementation examples, the web browser can request a webpage from a service indicated in the security policy for the login migration. The security policy can specify a URL and request type that can be used to create a request message and passed to the networking layer. At block 617, the web browser obtains a credential according to a login method that is compliant with the security policy. Assuming the policy requires a biometric login or hardware security token, the previously generated prompt would direct the user to either enter a biometric input or the web browser can interact with the security hardware component via an operating system of the endpoint to obtain a proper credential. After obtaining a credential that satisfies the security policy rule for the application or application class, the web browser submits an authentication request with the obtained credential via the networking layer. If the target or modern login includes a password generated by the web browser (e.g., migrating to multi-factor authentication (MFA) that includes a password), then the web browser will retrieve the password from the vault after successful authentication with the newly obtained credential. In some cases, the migration can leverage the position of the web browser to effectively create a SSO solution for a legacy application that did not support SSO. At block 619, the web browser securely stores an association of the proper credential and the application account identifier after receipt of the authentication token.

The example operations are described with reference to an identity security manager for consistency and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

### Variations

While the described examples refer to multiple use cases for identity security with web browser native functionality, the example use cases are not exhaustive. Native web browser identity security can also be leveraged to provide or support a Web-Based Promise Array Management (WebPAM) solution for monitoring and managing data storage, in particular redundant array of independent disks (RAID) storage virtualization technology. The expectation of periodically resetting passwords in a WebPAM solution can be handled with the disclosed native browser identity security that prevents exposure of the passwords to the rendering engine. In addition, the disclosed web browser technology can coordinate with AI technology or integrate AI technology to automate the password reset process. Instead of the inefficiency of manually developing a plug-in to detect how each website corresponding to a WebPAM solution resets passwords, the disclosed web browser can prompt a generative AI model to detect a reset method (e.g., via application programming interface (API) or UI) and build a plug-in for password reset accordingly. The generative AI model can be prompted with a URL to crawl a website to determine the reset method or be fed the encoding of the website (e.g., DOM and/or HTML) to determine the reset method. In the same or subsequent prompt, the generative AI model can be prompted to generate program code (e.g., build a plug-in) for the web browser to automatically reset the password with a natively generated and unrevealed password. Furthermore, the web browser can interact with a generative AI model to detect website change and update or revise the program code accordingly.

AI can be used for other aspects of the disclosed technology. A web browser can interact with a LLM when migrating legacy login methods or improving password hygiene. For instance, a web browser can interact with a LLM to detect registration events and/or distinguish between login failure and success events when setting a stronger password or migrating to a different login method. When a response is received, the web browser can securely communicate the response or header information of the response to a LLM for determining success or failure. As another example, the web browser can capture a web page (e.g., screen capture or underlying DOM/HTML) and provide the captured web page to include in the prompt to the LLM.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 7 can be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of: platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, which employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

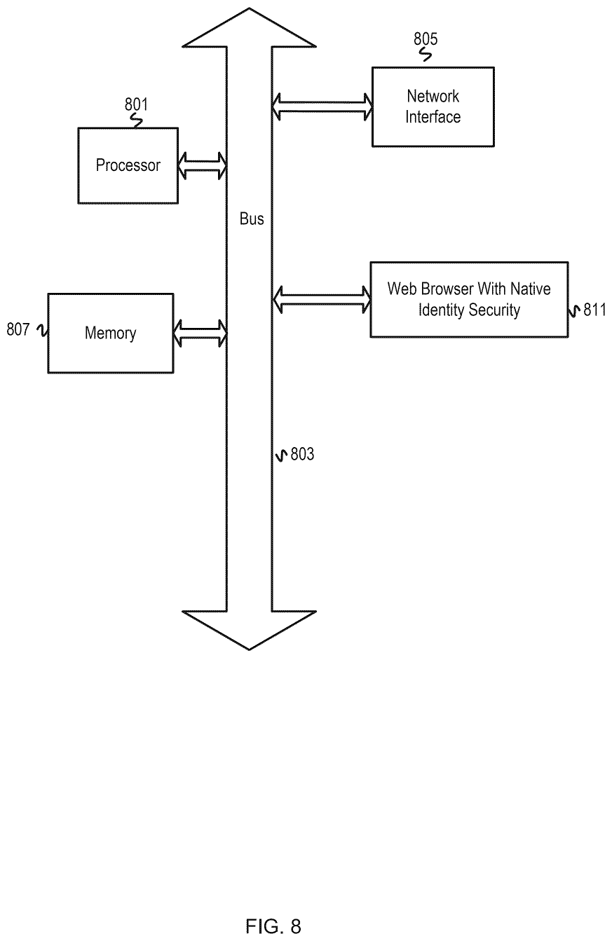

FIG. 8 depicts an example computer system with a web browser that includes native identity security. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes a web browser 811 with native identity security (“identity secure web browser”). The identity secure web browser 811 builds an inventory of identity security related data “at the source” and at a level within the browser architecture that casts a wider net by having visibility of logins traversing the web browser regardless of whether the browser is on a bring your own device (BYOD) device, an unmanaged device, a remote worker device, a contractor device, etc. Moreover, the identity secure web browser 811 can enforce password hygiene and other login related security rules, such as login migration requirements, natively and securely by preventing exposure of credentials via the rendering engine. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
monitoring events from a user interface subsystem of a web browser and from a network layer subsystem of the web browser for events related to login;
based on detecting a first login event from a user interface subsystem of a web browser, determining whether to set or reset a password;
based on determining that that the web browser should set or reset a password, natively generating a password within the web browser; and
presenting to a rendering engine of the web browser a mask string and preventing exposure of the generated password to the rendering engine;
inserting the generated password into a request message for resetting a password or setting a password for an application corresponding to the login event; and
transmitting the request message via a networking layer of the web browser.

2. The method of claim 1 further comprising identifying the application based on the first login event, wherein determining whether to set or reset a password comprises determining whether the identified application has already been protected with a browser generated password.

3. The method of claim 2, wherein determining whether the identified application has already been protected comprises accessing a secure memory by the web browser and determining whether the secure memory indicates a password for the identified application.

4. The method of claim 3 further comprising detecting a second login event for a second application, determining that a second password is indicated in the secure memory for the second application, and using the second password for a login request for the second application.

5. The method of claim 3 further comprising updating the secure memory with the password in association with an identifier of the identified application after receipt of an authentication response to the request message.

6. The method of claim 1 further comprising:
based on detecting a second login event from the user interface subsystem, evaluating the login event against a security policy enforced by the web browser;
determining that the second login event does not comply with the security policy;
if non-compliance corresponds to a password hygiene rule of the security policy, natively generating with the web browser a new password that complies with the security policy without exposing the new password to the rendering engine; and
if non-compliance corresponds to a legacy login migration rule of the security policy,
generating one or more prompts to obtain a credential that satisfies the legacy login migration rule; and
submitting, for authentication, the obtained credential to a second application corresponding to the second login event.

7. The method of claim 1 further comprising:
based on detection of a second login event from the user interface subsystem, extracting data from the second login event that at least indicates a login event type and application identifier;
based on detection of a response event from the network layer subsystem, extracting data from the response event that at least indicates an application identifier and authentication technique;
updating a local inventory of identity data within the web browser with the extracted data; and
communicating the local inventory of identity data to an identity security service for an organization.

8. A non-transitory, machine-readable medium having stored thereon program code comprising instructions to:
monitor events from a user interface subsystem of a web browser and from a network layer subsystem of the web browser for events related to login;
based on detecting a first login event from a user interface subsystem of a web browser, determine whether to set or reset a password;
based on a determination that that the web browser should set or reset a password, natively generate a password within the web browser; and
present to a rendering engine of the web browser a mask string and prevent exposure of the generated password to the rendering engine;
insert the generated password into a request message for resetting a password or setting a password for an application corresponding to the login event; and
transmit the request message via a networking layer of the web browser.

9. The non-transitory, machine-readable medium of claim 8, wherein the program code further comprises instructions to identify the application based on the first login event, wherein the instructions to determine whether to set or reset a password comprise instructions to determine whether the identified application has already been protected with a browser generated password.

10. The non-transitory, machine-readable medium of claim 9, wherein the instructions to determine whether the identified application has already been protected comprise instructions to access a secure memory by the web browser and to determine whether the secure memory indicates a password for the identified application.

11. The non-transitory, machine-readable medium of claim 10, wherein the program code further comprises instructions to detect a second login event for a second application, determine that a second password is indicated in the secure memory for the second application, and use the second password for a login request for the second application.

12. The non-transitory, machine-readable medium of claim 10, wherein the program code further comprises instructions to update the secure memory with the password in association with an identifier of the identified application after receipt of an authentication response to the request message.

13. The non-transitory, machine-readable medium of claim 8, wherein the program code further comprises instructions to:
based on detection of a second login event from the user interface subsystem, evaluate the login event against a security policy enforced by the web browser;
determine that the second login event does not comply with the security policy;
if non-compliance corresponds to a password hygiene rule of the security policy, natively generate with the web browser a new password that complies with the security policy without exposing the new password to the rendering engine; and
if non-compliance corresponds to a legacy login migration rule of the security policy,
generate one or more prompts to obtain a credential that satisfies the legacy login migration rule; and
submit, for authentication, the obtained credential to a second application corresponding to the second login event.

14. The non-transitory, machine-readable medium of claim 8, wherein the program code further comprises instructions to:
based on detection of a second login event from the user interface subsystem, extract data from the second login event that at least indicates a login event type and application identifier;
based on detection of a response event from the network layer subsystem, extract data from the response event that at least indicates an application identifier and authentication technique;
update a local inventory of identity data within the web browser with the extracted data; and
communicate the local inventory of identity data to an identity security service for an organization.

15. An apparatus comprising:
a processor; and
a non-transitory, machine-readable medium having stored thereon instructions executable by the processor to cause the apparatus to,
monitor events from a user interface subsystem of a web browser and from a network layer subsystem of the web browser for events related to login;
based on detecting a first login event from a user interface subsystem of a web browser, determine whether to set or reset a password;
based on a determination that that the web browser should set or reset a password, natively generate a password within the web browser; and
present to a rendering engine of the web browser a mask string and prevent exposure of the generated password to the rendering engine;
insert the generated password into a request message for resetting a password or setting a password for an application corresponding to the login event; and
transmit the request message via a networking layer of the web browser.

16. The apparatus of claim 15, wherein the machine-readable medium further has stored thereon instructions executable by the processor to cause the apparatus to identify the application based on the first login event, wherein the instructions to determine whether to set or reset a password comprise instructions executable by the processor to cause the apparatus to determine whether the identified application has already been protected with a browser generated password.

17. The apparatus of claim 16, wherein the instructions to determine whether the identified application has already been protected comprise instructions executable by the processor to cause the apparatus to access a secure memory by the web browser and to determine whether the secure memory indicates a password for the identified application.

18. The apparatus of claim 17, wherein the machine-readable medium further has stored thereon instructions executable by the processor to cause the apparatus to detect a second login event for a second application, determine that a second password is indicated in the secure memory for the second application, and use the second password for a login request for the second application.

19. The apparatus of claim 17, wherein the machine-readable medium further has stored thereon instructions executable by the processor to cause the apparatus to update the secure memory with the password in association with an identifier of the identified application after receipt of an authentication response to the request message.

20. The apparatus of claim 15, wherein the machine-readable medium further has stored thereon instructions executable by the processor to cause the apparatus to:
based on detection of a second login event from the user interface subsystem, evaluate the login event against a security policy enforced by the web browser;
determine that the second login event does not comply with the security policy;
if non-compliance corresponds to a password hygiene rule of the security policy, natively generate with the web browser a new password that complies with the security policy without exposing the new password to the rendering engine; and
if non-compliance corresponds to a legacy login migration rule of the security policy,
generate one or more prompts to obtain a credential that satisfies the legacy login migration rule; and
submit, for authentication, the obtained credential to a second application corresponding to the second login event.
